(19) United States
(12) Patent Application Publication
(10) Pub. No.: US 2022/0280930 A1
(43) Pub. Date: Sep. 8, 2022

(54) CATALYSER SUBSTRATES WITH POROUS COATING

(71) Applicant: UMICORE AG & CO. KG, Hanau-Wolfgang (DE)

(72) Inventors: Juergen KOCH, Hanau (DE); Martin FOERSTER, Büdingen (DE); Jan GILLEIR, Mortsel (BE); Pieter VAN GENECHTEN, Geel (BE)

(73) Assignee: UMICORE AG & CO. KG, Hanau-Wolfgang (DE)

(21) Appl. No.: 17/632,700

(22) PCT Filed: Jul. 31, 2020
(86) PCT No.: PCT/EP2020/071661

§ 371 Date: Feb. 3, 2022

(30) Foreign Application Priority Data
Aug. 5, 2019 (DE) 10 2019 121 084.4

(51) Int. Cl. B01J 37/02; B01J 35/10; B01J 37/00

(52) U.S. Cl. CPC B01J 37/0219; B01J 35/10; B01J 37/0018

(57) ABSTRACT

The invention relates to a coating suspension for producing catalysts, to a corresponding method and to the catalysts themselves. In particular, a coating suspension is used during the production of the catalysts which leads to a porous catalytic coating.

The present invention relates to coating suspensions for coating catalyst substrates, to a method for coating catalyst substrates, and to a catalyst substrate coated according to the invention. In particular, a coating suspension, by means of which a porous layer can be produced, is used in the production of the coated catalyst substrates.

The exhaust gas of internal combustion engines in motor vehicles typically contains the harmful gases carbon monoxide (CO) and hydrocarbons (HC), nitrogen oxides (NOx) and possibly sulfur oxides (SOx), as well as particles that predominantly consist of nanometer-scale soot particles, possibly adherent organic agglomerates and ash residues. These are called primary emissions. CO, HC, and particles are the products of the incomplete combustion of the fuel inside the combustion chamber of the engine. Nitrogen oxides form in the cylinder from nitrogen and oxygen in the intake air when the combustion temperatures locally exceed 1400° C. Sulfur oxides result from the combustion of organic sulfur compounds, small amounts of which are always present in non-synthetic fuels. In order to remove these emissions, which are harmful to health and environment, from the exhaust gases of motor vehicles, a variety of catalytic technologies for the purification of exhaust gases have been developed, the fundamental principle of which is usually based upon guiding the exhaust gas that needs purification over a flow-through or wall-flow honeycomb body or monolith with a catalytically active coating applied thereto.

The catalyst in the coating promotes the chemical reaction of various exhaust gas components while forming non-harmful products such as carbon dioxide and water, wherein the wall-flow filter additionally removes the harmful soot and ash particles from the exhaust gas as the exhaust gas flow passes through the porous walls of the filter, Particularly in the case of coated flow-through substrates, but also in the case of wall-flow filter substrates with a coating on the channel walls, it is necessary for the catalytic coating to have a certain porosity with open pores which can be flowed through, and thus good gas permeability. On the one hand, the porosity and thus higher free surface area of the porous layer enables better accessibility of the exhaust gas to the catalytically active constituents in the layer, and on the other, it only allows free access and passage of the gas to the porous filter wall. In the case of a largely closed, impervious coating on the porous filter walls, the exhaust gas back pressure would increase to an unacceptably great extent and thus lead to a reduction in the torque of the engine and possibly to increased fuel consumption. It is therefore desirable, in particular for filter applications, for the catalytic coating to have a porous structure which has good gas permeability and does not substantially increase the exhaust gas back pressure.

Coated catalyst substrates consisting of a temperature-stable honeycomb body made of metal or ceramic are produced by bringing the substrates into contact with a coating suspension (washcoat). The coating suspension consists of a slurry of inorganic coating materials (e.g. aluminum oxide, titanium oxide), catalytically active precious metals such as platinum, palladium, or rhodium, as well as possibly other constituents such as oxygen storage materials or other catalytically active substances such as zeolites. In order to adjust the viscosity and further rheological properties of the suspensions, they may also contain thickeners, wetting agents, defoamers or sedimentation inhibitors. After the substrates have been coated with the liquid washcoat, they are dried and calcined at a temperature of 500° C. to 700° C., thereby forming a tightly adherent oxide layer in which the catalytically active elements are embedded.

Efforts have frequently been made in the past to increase the porosity of these catalytically active coatings on filter or flow-through substrates. Porosity is generally understood to mean the ratio of the void volume of the pores to the total volume of a substance or a body. In order to increase the accessibility of the free surface and the gas permeability of coatings, the open pores which can be flowed through and which are connected to each other and to the environment are in particular of importance. The fraction of the porosity which is determined by closed pores is not relevant to the gas permeability and accessibility to the catalytically active centers.

WO2009049795 discloses a coating suspension and a method for coating catalyst substrates with the coating suspension, which contains an inorganic carrier material and a polymeric pore former, consisting of agglomerated polymeric primary particles having a diameter of 0.5 μm to 2 μm and being present in the coating suspension at up to 8 wt %. The polymeric pore formers are here selected from the group of synthetic polymers such as polyethylene, polypropylene, polyurethanes, polyacrylonitriles, polyacrylates, polymethacrylates, polyvinyl acetates or polystyrene. After the coating suspension has been applied and dried at 120° C., the organic polymeric pore former in the layer is burned out by a temperature treatment at 550° C. to form the pores. The patent specification does not provide any information regarding the extent to which the porosity of the coating was increased by the addition of the pore formers.

The same principle for producing pores in a catalytic coating using organic pore formers that are burned out at a higher temperature is described in WO2017209083 A1. This application claims a porous catalytically active layer on the walls of a filter for purifying exhaust gases. The porous layer has a defined porosity and pore size distribution and is produced by means of a coating suspension containing a catalytically active carrier material and an organic pore former. Substances such as starch, carbon or activated carbon powder and organic polymers such as polyethylene, polypropylene, melamine or polymethyl methacrylate resins, having a particle size of 2 μm to 20 μm, are proposed as possible pore formers. The ratio of the volume of the pore former to the volume of the carrier material is in the range of from 3 to 1 up to 15 to 1. The pore structure of the layer is produced by burning off the organic pore former at 500° C. WO08153828 A2 also discloses a method for producing porous layers from inorganic particles. In this document, thermally decomposable powders, such as protein, starch, or polymer particles, are used as pore formers for inorganic membranes.

All these solutions share the commonality of containing a considerable volume fraction of pore formers made of organic particles relative to the solids content of the suspension, in order to produce a sufficiently high porosity of the layer. In order to produce a layer having a porosity of approximately 50 vol % (comparable to the porosity of the channel walls of filter substrates) and purely by way of an example calculation, a pore former content of approximately 20 wt % results from the pure density of aluminum oxide (3.95 g/cm³) and polyethylene resin (0.9 g/cm³) as organic pore former. This high proportion of organics in the coating suspension results in a considerable amount of organic decomposition products being produced during the calcination of the layer. Depending on the polymer used, said organic decomposition products can lead to an atmosphere at risk of explosion in the calcination furnaces and can also be harmful to health. They must then be removed from the exhaust gas by an expensive and complex thermal post-combustion. In addition, there is the risk that, due to the high content of organic additives with an incomplete thermal decomposition, a large amount of undesirable residues remain in the layer and the catalytic effectiveness is thereby reduced.

There is thus still a need for a solution for the stated problem of producing a porous, catalytically active coating on catalyst substrates by means of a pore former, without considerable amounts of organic decomposition products being produced during the calcination. The invention was thus based on the object of providing a coating suspension and a method for producing a porous, catalytically active coating on a catalyst substrate, which coating has a high porosity and free surface area and only low organic emissions occur during the production. Furthermore, the object of the invention is that of providing a catalyst comprising a catalyst substrate with a porous coating.

The object is achieved by a coating suspension for coating carrier substrates, which has at least one inorganic coating material and at least one polymeric organic pore former, wherein the polymeric pore former is composed of water-insoluble, swollen particles having a water content of 40 wt % to 99.5 wt %. Entirely surprisingly, these swollen polymeric pore formers shrink only slightly with a high water content in the applied catalytic coating suspension during the drying process. They substantially maintain their shape and size during drying and thus prevent the pulverulent coating materials from forming a closed impervious layer. It is only during the final calcination that they disappear as a result of thermal decomposition but in so doing naturally leave behind a corresponding pore. Since the swollen polymeric pore formers have a high water content of 40-99.5%, preferably 70-98%, very preferably 80-95%, the amount of organic decomposition products from the polymers forming them is very small compared to the organic pore formers commonly used. Pore formers such as carbon (graphite, activated carbon, petroleum coke, and carbon black), starches (such as corn, barley, beans, potatoes, rice, tapioca, peas, sago palm, wheat, canna), rice and walnut shell flour and polymers (such as polybutylene, polymethylpentene, polyethylene, polypropylene, polystyrene, polyamides, epoxy resins, ABS, acrylates and polyesters) already belong to the prior art.

Preference is given to using what are referred to as hydrogels as water-insoluble, swollen particles. Hydrogels are generally understood to mean a water-containing but water-insoluble polymer, the molecules of which are chemically linked, e.g., by covalent or ionic bonds, or physically linked, e.g., by entangling the polymer chains, to form a three-dimensional network. Due to incorporated hydrophilic polymer components, they swell in water with a considerable increase in volume, but without losing their material cohesion (“Hydrogel” entry in: Wikipedia, The free Encyclopedia; version valid as of: 18 Nov. 2018, 03:24 UTC; URL: https://de.wikipedia.org/w/index.php?title=Hydrogel&oldid=182851302; Enas M. Ahmed, Hydrogel: Preparation, characterization, and applications: A review, Journal of Advanced Research (2015) 6, 105-121). Preferably, the polymer forming the hydrogel comprises a polymer selected from the group of the natural polymers alginates, carrageenans, xanthans, dextrans, pectins, gelatins, hyaluronic acids, chitosans or the group of the synthetic polymers polyacrylates, polyvinyl alcohols, polymethacrylates, polyvinylpyrrolidones, polyethylene glycol acrylates/methacrylates (PEGA/PEGMA), and polystyrenes or mixtures of these polymers. Swollen hydrogels based on alginates, carrageenans, gelatins and polyacrylates are particularly suitable as pore formers. The polymeric pore former preferably consists of spherical hydrogel particles with an average diameter d50 of 1 μm to 100 μm, preferably 10 μm to 50 μm, very preferably 10 μm to 30 μm (measured using a laser diffraction method according to ISO 13320-1, latest version valid on the date of application).

The shape of the hydrogel particles may also be irregular or cylindrical and fibrous. In the case of fibrous or cylindrical hydrogel particles, the mean diameter d50 measured by laser diffraction is also 1 μm to 100 μm, preferably 5 μm to 50 μm, wherein the particles may preferably have a length to diameter aspect ratio of 50 to 1 to 2 to 1, preferably 20 to 1 to 5 to 1. Irregular shapes and other geometric shapes of the hydrogel particles can, of course, also be used within the scope of this invention.

The weight ratio of the polymeric pore former made of swollen particles relative to the solids content of the coating suspension is from 1:40 to 1:0.7 in the coating suspension. In a preferred embodiment, this is 1:20 to 1:2 and very particularly preferably 1:10 to 1:3. If the weight ratio of hydrogel to solid in the suspension is less than 0.025, too little additional porosity is produced in the layer to have positive effects. While larger amounts of hydrogel particles above the ratio of 1:0.7 do further increase the porosity, they can however ultimately lead to an overall excessively low loading of the catalyst substrates and to an excessively low adhesion resistance and abrasion resistance of the coating. A person skilled in the art will be able to find the correct value for the underlying coating problem.

In addition to the pore former, the coating suspension according to the invention has at least one inorganic coating material. This can be designed by a person skilled in the art in accordance with the materials that are appropriate for the present purpose. As a rule, these are materials made of oxides of the metals from the group of aluminum, silicon, titanium, zirconium, hafnium, cerium, lanthanum, yttrium, neodymium, praseodymium, and mixtures thereof, mixed oxides and/or zeolites. The material particularly preferably comprises oxides of aluminum, cerium, zirconium or cerium-zirconium. These can be provided in small amounts (1-10 wt %) with stabilizers from the group of barium, lanthanum, yttrium, praseodymium, neodymium. As a rule, these are high surface compounds (more than 10 m²/g to 400 m²/g BET surface area measured according to DIN 66132-latest version on the date of application), which withstand a correspondingly high thermal load.

The coating materials which have just been mentioned are often provided with metals which are catalytically active in exhaust gas purification. Consequently, the coating material can additionally contain catalytically active metals from the group of iron, copper, platinum, palladium, rhodium, cobalt, nickel, ruthenium, iridium, gold and silver and/or mixtures thereof in the form of salts, oxides or in metallic form.

In the present context, particular preference is given to iron or copper ion-exchanged zeolites, in particular those of the CHA, AEI or ERI type. Preference is further given to mixtures or mixed oxides based on aluminum, cerium and zirconium, which are provided with palladium and/or rhodium. Catalytically active coating materials based on aluminum, which are provided with platinum and/or palladium, can also be preferably used. Suitable catalytically active coatings can also be found by a person skilled in the art in the following document: WO2011151711 A1.

The solids content of the coating suspension according to the invention can be determined by a person skilled in the art. The inorganic coating material (e.g., oxides, zeolites, oxides containing precious metals, etc.) also varies in the form of further solid additives (e.g., oxygen storage materials, mixed oxides, stabilizers, etc.) depending on the coating suspension and is generally between 20 wt % and 55 wt %, preferably 25 wt %-50 wt % and very preferably 30 wt %-45 wt % relative to the suspension.

The carrier substrates to be coated with the coating suspension according to the invention are either flow-through substrates or wall-flow filter substrates. The carrier substrates are also generally referred to as catalyst substrates, catalyst carriers, honeycomb bodies, substrates or monoliths. Flow-through monoliths are conventional catalyst substrates in the prior art, which can consist of metal (corrugated carrier, for example WO17153239A1, WO16057285A1, WO15121910A1 and literature cited therein) or ceramic materials. Refractory ceramics, such as cordierite, silicon carbide or aluminum titanate, etc. are preferably used. The number of channels per area is characterized by the cell density, which typically ranges between 300 and 900 cells per square inch (cpsi). The wall thickness of the channel walls in ceramics is between 0.5-0.05 mm.

All ceramic materials customary in the prior art can be used as wall flow monoliths or wall flow filters. Porous wall flow filter substrates made of cordierite, silicon carbide, or aluminum titanate are preferably used. These wall flow filter substrates have inflow and outflow channels, wherein the respective downstream ends of the inflow channels and the upstream ends of the outflow channels are alternately closed off with gas-tight “plugs.” In this case, the exhaust gas that is to be purified and that flows through the filter substrate is forced to pass through the porous wall between the inflow channel and outflow channel, which delivers an excellent particle filtering effect. The filtration property for particulates can be designed by means of porosity, pore/radii distribution, and thickness of the wall. The catalyst material can be applied to the porous walls of the inlet and outlet channels in the form of the coating suspension according to the invention. The porosity of the wall-flow filters is generally more than 40%, generally from 40% to 75%, particularly from 45% to 70% [as measured in accordance with DIN 66133, latest version on the filing date]. The average pore size (diameter) is at least 7 μm, for example from 7 μm to 34 μm, preferably more than 10 μm, in particular from 10 μm to 20 μm, or from 21 μm to 33 μm [measured according to DIN 66134, latest version on the date of application].

With a sufficiently small particle size of the hydrogel particles and the remaining solid components of the coating suspension (in the case of standard filters with an average pore size of approx. 15 μm to 20 μm, generally <5 μm), what are referred to as in-wall coatings, in which a porous coating then forms on the surfaces of the pores in the channel walls, can also be produced with the coating suspension according to the invention. This is of particular interest for wall-flow filters, since in this case there is frequently the highest possible amount of catalytically active material located in the wall. As a result, the exhaust gas back pressure can be furthermore positively influenced without compromising on catalytic activity.

It is also possible to use the suspension according to the invention for coating flow-through substrates. The porous structure of the coating on the channel walls increases the free accessible surface area, and the turbulence of the exhaust gas results in better exchange and thus in an improvement in the catalytic reaction. The on-wall coating of a flow-through substrate produced by the hydrogel particles as pore former is illustrated in FIG. 2.

In addition to the swollen pore formers used in the coating suspension according to the invention, further fillers can be present in an amount from 1 wt % to 10 wt %, preferably 2 wt % 8 wt %, very preferably 4 wt %-6 wt % relative to the amount of coating suspension. Further pore formers, for example, may be used, in particular those which are designed to be fibrous. This admixture can lead to the individual fibers coming into contact with different swollen pore formers of the coating suspension and thus, after burning out, the individual pores caused by the swollen pore formers in the solid coating suspension crosslink with one another through tunnels (FIG. 4). As a result, the gas passage through the porous coating can be even further minimized, since the probability of defined passages therethrough is increased for the exhaust gas. Such pore formers can be selected arbitrarily by a person skilled in the art. They generally have a length to width ratio of 50 to 1 to 2 to 1, preferably 20 to 1 to 5 to 1.

The water-insoluble, swollen pore formers, for example the hydrogel particles, used for pore formation in the coating suspension can consist only of water and the organic gel-forming polymer, or they can also contain further fillers or be chemically modified. For example, the swollen hydrogel particles can additionally contain fibrous fillers or fillers having a high surface area in the gel particles, which remain in the pores formed after drying and burning out the hydrogel particles and thus, for example, increase the particle filtration efficiency.

Very preferably, the polymeric pore former may contain, for example in the form of hydrogels, catalytically active metals or precursors for catalytically active metals. The pore formers made from the hydrogel particles, for example, may likewise contain, for example, oxides free of precious metals or oxides containing precious metals as fillers, as already mentioned above, which after burning out the hydrogel particles that are preferably used partially fill the resulting pores and improve the catalytic activity, for example soot burn-off or the oxidation effect of the finished coating. The proportion of fillers in the swollen, preferably hydrogel, particles is to be selected such that a loose, gas-permeable filling of the pores results after decomposition of the hydrogels. Substances with a storage function for oxygen, nitrogen oxides or organic compounds, such as cerium, zirconium or barium oxides or mixed oxides or ion-exchanged zeolites, are also conceivable as fillers in the swollen hydrogel particles. In principle, all active substances known to a person skilled in the art for exhaust gas purification can be used here. Advantageously, after decomposition of the hydrogels preferably used, the components active in the exhaust gas are thus located specifically at the locations where the flow, substance transfer or diffusion preferably takes place. They are thus in close contact with the largest material flows. Typically, this further filler is present in an amount of 1 wt % to 10 wt %, preferably 2 wt %-8 wt %, particularly preferably 4 wt %-6 wt % relative to the amount of coating suspension.

FIG. 3 outlines an on-wall coating of a filter wall with loosely filled pores. Alternatively, a chemical modification of the pore formers can also be achieved, for example, by subsequently absorbing precious metals on or into the swollen water-insoluble hydrogel particles after their production (see examples 1 to 3) (Journal of Molecular Liquids Volume 276, 15 Feb. 2019, pages 927-935). Hydrogel particles with a shell-shaped construction are also possible by only the regions close to the surface being chemically modified. For example, by briefly introducing hydrogel particles into a precious metal solution only in the regions of the particles close to the surface, precious metal could be absorbed, which remains on the walls of the pores formed after the thermal decomposition of the preferred hydrogels. Very preferably, the hydrogel may have the aforementioned possibly catalytically activated coating material as filler to the extent just mentioned.

The coating suspension is preferably applied to the catalyst carrier in what is referred to as a coating process. Many such processes in this sense were published in the past by automotive exhaust-gas catalyst manufacturers (EP1064094B1, EP2521618B1, WO10015573A2, EP1136462B1, U.S. Pat. Nos. 6,478,874, 4,609,563, WO9947260A1, JP5378659B2, EP2415522A1, JP2014205108A2).

U.S. Pat. No. 6,478,874 states that a vacuum is used to draw a washcoat suspension upwardly through the channels of a substrate monolith. U.S. Pat. No. 4,609,563 describes a process in which a metered charging system is used for the catalytic coating of a substrate. This system comprises a method of coating a ceramic monolithic substrate with a precisely controlled, predetermined amount of the washcoat suspension using a vacuum (hereinafter “metered charge”). The monolithic substrate is immersed in a quantitatively determined amount of washcoat suspension. The washcoat suspension is then drawn by the vacuum into the substrate monolith. In this case, however, it is difficult to coat the monolithic substrate in such a way that the coating profiles of the channels in the monolithic substrate are uniform.

In contrast, a process is also established with which a specific amount of washcoat suspension (metered charge) is applied to the top side of an upright substrate monolith, this amount being such that it is practically completely retained within the monolith provided (US6599570). By means of a vacuum/pressure device acting on one of the ends of the monolith, the washcoat suspension is sucked/pressed entirely into the monolith without excess suspension escaping at the lower end of the monolith (WO9947260A1). See in this context also JP5378659B2, EP2415522A1 and JP2014205108A2 of the Cataler company.

Very particularly preferably, the catalyst substrate for the use of the suspension according to the invention is a wall-flow filter. Said wall-flow filter has a loading with the dry coating suspension of 30 to 200 g/l, preferably 50 to 160 g/l, and most particularly preferably 60 to 145 g/l. The gas permeability, and thus the porosity of the catalyst layer, is critical for functional capability and for achieving the lowest possible exhaust-gas back pressure of the coated wall-flow filter.

After coating the catalyst carrier with the coating suspension according to the invention, it is dried. The layer can be dried at room temperature or with an increase in temperature to 80° C. to 180° C. in a batch or continuous furnace. In this case, the water evaporates first from the layer and also to a certain extent from the hydrogel particles, the latter, however, largely retaining their size. The catalyst supports are then heated to a temperature of 500° C. to 700° C. and calcined, wherein the organic fraction of the pore former contained in the coating is burned out of the water-insoluble, swollen particles. The pore diameter after burning out is dependent on the starting diameter of the hydrogel particles and can be set by selecting a suitable particle size distribution of the hydrogel particles. Coating a wall-flow filter in this way makes it possible to ensure a sufficiently high gas permeability which prevents the exhaust gas back pressure from increasing excessively. This results in a porous catalytically active layer on the surfaces of the substrate, which has increasing numbers of pores with a diameter in the order of magnitude of 1 μm to 100 μm, preferably 10 μm to 50 μm, very particularly preferably 10 μm-30 μm (determined via optical length analysis of the pore diameter in a SEM or microscope image of a plurality of cuts (e.g., 10) of the layer and calculating the mean value).

A typical design and structure of the coating on a porous ceramic substrate is shown in the scanning electron micrograph (SEM) in FIG. 5. The significantly increased porosity of the coating according to the invention can be seen here compared to a suspension which contains water-insoluble swollen particles as pore former in comparison with a layer which was produced without pore formers. In the case of filters with a coating layer on the cell wall, this results in the object of allowing the exhaust gas to flow through the coating layer with the lowest possible pressure loss. This is better enabled by the cavities that the decomposed hydrogels leave behind (FIG. 1).

In a preferred embodiment of the invention, depending on the starting material, the porosity is increased by at least 30%, more preferably by 40% and very preferably by 50% by the addition of the swollen polymers (relative porosity increase). Here, an upper limit is created by the fact that as porosity increases, the amount of catalytically active material decreases or the adhesion of the layer is possibly impaired. Depending on the application, the porosity of the coating produced by the use of hydrogel particles as pore former should be increased to a value between 5% and 75% (absolute porosity). The porosity of the applied coating can be determined, for example, by an image analysis of a SEM image of one or more cross-sectional cuts of a calcined layer (as already shown above).

By using the coating suspension according to the invention with, for example, hydrogel particles as pore formers, porous coatings which have good gas permeability can be produced on and/or in the channel walls of filter substrates (wall-flow) and on flow-through substrates. Filters with such a coating have a lower exhaust gas back pressure than filters which are produced using conventional coating suspensions without pore formers. FIG. 1 schematically shows the gas flow through the cavities resulting from the decomposition of the hydrogel particles in the layer.

The present invention also relates to a method for producing a porous coating on carrier substrates by providing a coating suspension which has at least one inorganic coating material and at least one polymeric organic pore former, characterized in that the polymeric pore former is composed of water-insoluble, swollen particles having a water content of 40 wt % to 99.5 wt % relative to the hydrogel particles, coating the carrier substrate with the coating suspension, and drying and calcining the coated carrier substrate. The preferred embodiments for the coating suspension also apply, mutatis mutandis, to the method addressed here.

The correspondingly produced carrier substrates can be successfully used for post-treatment of exhaust gases from a car engine. In principle, all exhaust gas aftertreatments which are suitable to a person skilled in the art for this purpose can be used as such. As mentioned, zeolites are present, inter alia, in TWCs (three-way catalysts), DOCs (diesel oxidation catalysts), PNAs (passive NOx absorbers) LNTs (nitrogen oxide storage catalysts), and in particular in SCR catalytic converters. The catalysts produced using the method according to the invention are suitable for all these applications. The use of these catalytic converters for the treatment of exhaust gases of a lean burning car engine is preferred.

### DESCRIPTION OF THE FIGURES

FIG. 1: Schematic depiction of the coating according to the invention of a wall-flow filter.

FIG. 2: Schematic depiction of the coating according to the invention of a flow-through substrate.

FIG. 3: Schematic depiction of the coating according to the invention of a wall-flow filter with filler in the pores.

FIG. 4: Schematic depiction of the coating according to the invention of a wall-flow filter with channel-like connections of the pores by additional pore formers.

FIG. 5: Comparison of the porosities of a coating with (bottom) and without (top) pore former.

FIG. 6: Light micrograph of the alginate hydrogel particles

FIG. 7: Particle size distribution of the alginate hydrogel particles (D50: 30 μm; D90: 53 μm); measured according to the laser diffraction method according to ISO 13320-1 Particle Size Analysis Laser Diffraction Methods

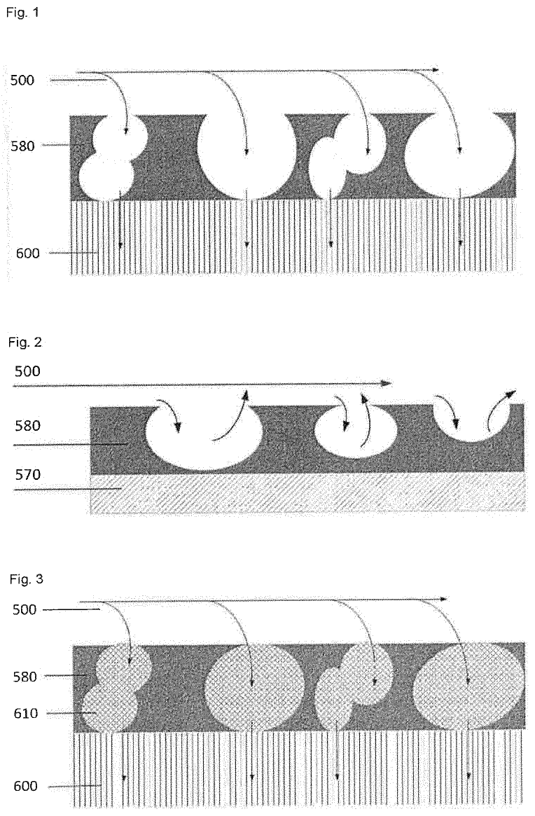

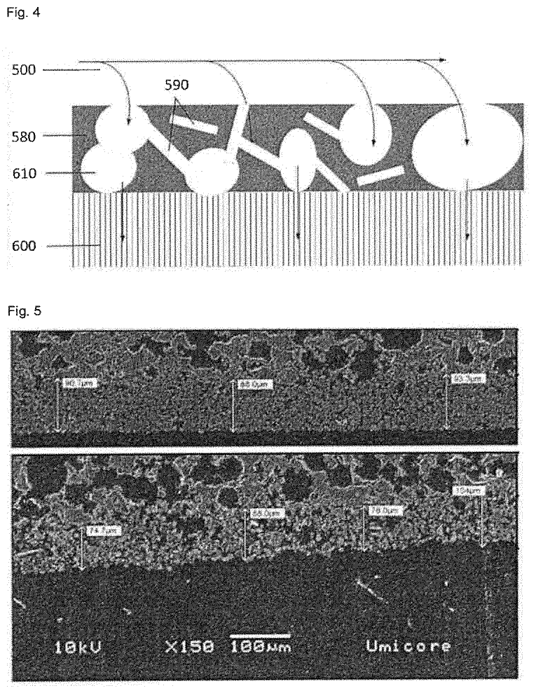

### LEGEND FOR THE FIGURES

500 Exhaust gas
570 Cell wall of the substrate
580 Washcoat
590 Tunnel-shaped connecting pores
600 Cell wall of the filter substrate
610 Filler or enriched functional materials made of the decomposed hydrogels

### Examples

As such, the swollen polymeric pore formers containing water (hydrogel particles) are not commercially available, but rather are separately prepared as described in the examples before incorporation into the coating suspension.

### A. Production of Alginate Hydrogel Particles

The production of hydrogel particles based on alginates has long been described in the literature (see, for example, Wan-Ping Voo, European Polymer Journal 75 (2016) 343-353; Aurelie Schoubben, Chemical Engineering Journal 160 (2010) 363-369). From the available literature, a person skilled in the art can easily identify the optimal process parameters in order to prepare water-insoluble swollen alginate hydrogel particles having a particle diameter of 5 μm to 100 μm.

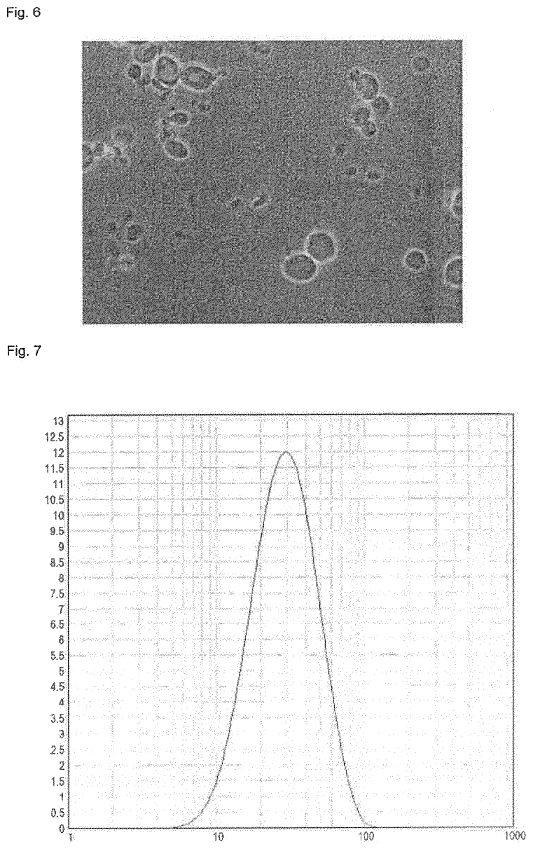

By way of example, in one experiment, a 2% sodium alginate solution was sprayed via a spray nozzle into a 5% calcium chloride solution with stirring. The calcium ions lead to spontaneous gelling of the alginate droplets upon impact with the liquid surface. The resulting calcium alginate beads were stirred in the solution for an additional two hours to complete the swelling process and were then separated from the solution by centrifugation or filtration. The particles exhibited a predominantly spherical shape with an average particle diameter d50 of 29 μm (median value of the Q3 distribution measured according to ISO 13320-1, latest version valid on the date of application) and a water content of 95%. FIG. 6 shows a light micrograph of the alginate hydrogel particles; FIG. 7 shows the particle size distribution.

Other water-soluble calcium salts can also be used instead of calcium chloride. According to the general method described here, pore formers made of alginate hydrogel particles can also be produced with other polyvalent cations which form water-insoluble, swollen hydrogel particles. For example, alginate hydrogel particles can be produced by precipitation and exchange of the sodium with polyvalent cations of the second and third main groups (e.g., strontium, barium, aluminum, etc.), polyvalent cations of the transition metals (nickel, copper, platinum, palladium, rhodium, etc.), or cations of the rare earth metals, such as cerium or lanthanum. In this way, in addition to the pore-forming function, catalytically active elements can also be introduced via the hydrogel particles into the washcoat layer and remain in the pores formed from them after the hydrogels have been burnt off.

### B. Production of Crosslinked Gelatin Hydrogel Particles

20 g gelatin (Imagel DP®, Gelita) are suspended in 180 g water and allowed to swell at room temperature for one hour. A clear solution is produced by heating to 40° C. In a second vessel, a clear, 10% PVA solution is prepared by dissolving 50 g polyvinyl alcohol (e.g., Mowiol® 4-98, CAS Number 9002-89-5, Sigma-Aldrich) in 450 g water with stirring at 90° C.

175 g of water and 175 g of gelatin solution (both heated to 40° C.) are added to 350 g of the PVA solution with stirring at 40° C., stirred for 15 minutes at 40° C., and then cooled to room temperature with stirring.

To crosslink the gelatins, 350 μl of a 50% aqueous glutaraldehyde solution (CAS Number: 111-30-8, Sigma-Aldrich) are added to this solution and stirred overnight. The precipitated hydrogel particles made of crosslinked gelatin are centrifuged off from the remaining solution. The hydrogel particles are predominantly spherical with an average particle diameter d50 of 9 μm and a water content of 91.3 wt %.

### C. Production of Polyacrylate Hydrogel Particles

A commercially available sodium polyacrylate was used to produce the polyacrylate hydrogel particles (e.g. Sigma Aldrich, CAS Number 9003-04-7). This substance is also known in the art as a superabsorber since it is capable of absorbing a multiple of its own weight in polar liquids, for example water, and thereby forming a hydrogel. In order to produce the swollen hydrogel particles made of polyacrylate, 5 g of sodium polyacrylate is added to one liter of water with stirring. After the swelling process, which ends after a few minutes, the suspension is precomminuted with a standing mixer and then ground in a ball mill with aluminum oxide spheres (1 mm) to a mean particle diameter d50 of 50 μm.

### Production of a Coating Suspension According to the Invention

In order to demonstrate the effectiveness of the pore formers according to the invention, a washcoat containing zeolite and having SCR functionality was mixed with the alginate- and gelatin-based hydrogel particles (experiments A and B) in the ratios indicated in table 1. The solids content of the washcoat suspension before the addition of the hydrogel particles was 49.8 wt %. The washcoat was initially charged in a stirring vessel and the corresponding amount of swollen hydrogel particles was added with stirring. The resulting coating suspension was subsequently spread onto a porous ceramic plate, dried and calcined at 550° C., The layer thickness of the calcined layer was between 80 μm and 150 μm. In order to determine porosity, the coated ceramic plate was embedded in a synthetic resin and sections thereof were analyzed in a scanning electron microscope. The SEM image was then examined electronically in an image analysis program (Zeiss Axio Software). To this end, a defined RGB value was assigned to a black and white SEM image and the area ratio of the RGB values in an analysis window was analyzed in order to computationally determine the porosity.

TABLE 1
Composition and characterization of the coating suspensions

| | | | | Proportion | |
|---|---|---|---|---|---|
| | | | | of organics | Porosity |
| | Washcoat | Mass | Mass | before | of the |
| | mass | Hydrogel | organics | calcination | layer |
| Pore former | [g] | [g] | [g] | [wt. %] | [%] |
| Reference - | 25.0 | 0.0 | 0.00 | 0.0 | 12.9 |
| no hydrogel | | | | | |
| Alginate | 25.0 | 4.5 | 0.25 | 2.0 | 18.5 |
| hydrogel | | | | | |
| Alginate | 25.0 | 11.5 | 0.64 | 4.9 | 27.2 |
| hydrogel | | | | | |
| Gelatin | 25.0 | 3.0 | 0.26 | 2.1 | 17.0 |
| hydrogel | | | | | |
| Gelatin | 25.0 | 7.5 | 0.65 | 5.0 | 20.5 |
| hydrogel | | | | | |

| | |
|---|---|
| Solids content of the washcoat (coating material) | 49.8 wt % |
| Water content of alginate hydrogel particles | 94.4 wt % |
| Water content of gelatin hydrogel particles | 91.3 wt % |

It can be seen from table 1 that the porosity of the layer (determined via image analysis methods as described above) doubles on average in the dried layer, in comparison with a suspension without hydrogel particles, by using the suspension according to the invention with the pore formers made of swollen hydrogel particles with a very low organics proportion of 5 wt %.

1. A coating suspension for coating carrier substrates, which has at least one inorganic coating material and at least one polymeric organic pore former,
characterized in that
the polymeric pore former is composed of water-insoluble, swollen particles having a water content of 40 wt % to 99.5 wt %.

2. The coating suspension according to claim 1,
characterized in that
the polymeric pore former is a hydrogel from the group of the natural polymers alginates, carrageenans, xanthans, dextrans, pectins, gelatins, hyaluronic acids, chitosans or the group of the synthetic polymers polyacrylates, polyvinyl alcohols, polymethacrylates, polyvinylpyrrolidones, polyethylene glycol acrylates/methacrylates (PEGA/PEGMA), and polystyrenes.

3. The coating suspension according to claim 1,
characterized in that
the polymeric pore former made of swollen particles has a diameter, using the d50 average, of 1 μm to 100 μm.

4. The coating suspension according to claim 1,
characterized in that
the weight ratio of the polymeric pore former made of swollen particles relative to the solids content of the coating suspension is from 1:40 to 1:0.7 in the coating suspension.

5. The coating suspension according to claim 1,
characterized in that
the inorganic coating material has oxides of the metals from the group of aluminum, silicon, titanium, zirconium, hafnium, cerium, lanthanum, yttrium, neodymium, praseodymium, and mixtures thereof, mixed oxides and/or zeolites.

6. The coating suspension according to claim 5,
characterized in that
the coating material additionally contains catalytically active metals from the group of platinum, palladium, rhodium, cobalt, nickel, ruthenium, iridium, gold and silver and/or mixtures thereof in the form of salts, oxides or in metallic form.

7. The coating suspension according to claim 1,
characterized in that
in addition to the swollen pore formers, said coating suspension has 1 to 10 wt % of a further filler.

8. The coating suspension according to claim 1,
characterized in that
the polymeric pore former may contain further fillers.

9. The coating suspension according to claim 1,
characterized in that
the polymeric pore former contains catalytically active metals or precursors for catalytically active metals.

10. A method for producing a porous coating on carrier substrates by providing a coating suspension which has at least one inorganic coating material and at least one polymeric organic pore former,
characterized in that
the polymeric pore former is composed of water-insoluble swollen particles having a water content of 40 wt % to 99.5 wt %, coating the carrier substrate with the coating suspension, and drying and calcining the coated carrier substrate.

11. A carrier substrate produced according to claim 10.
